(19) United States
(12) Patent Application Publication
(10) Pub. No.: US 2005/0110459 A1
(43) Pub. Date: May 26, 2005

(54) Bed buddy

(76) Inventor: Theodore William Buselmeier, St. Paul, MN (US)

Correspondence Address: Theodore William Buselmeier, 579 Bidwell Ave, St. Paul, MN, 55107, US

(21) Appl. No.: 10/966,446

(22) Filed: Oct. 15, 2004

Related U.S. Application Data
(60) Provisional application No. 60/511,941, filed on Oct. 15, 2003.

(51) Int. Cl. H02J 7/04

(52) U.S. Cl. 320/115

(57) ABSTRACT

The present invention is a novel and unobvious localized heat source. This additional localized heat source is for the benefit of a specific area. It is a safe, efficient, energy saving method of staying warm. It is a small rechargeable object that gets warm. It is for people to sleep or snuggle with when they need additional heat especially when temperatures drop. Instead of heating the whole room with a costly space heater, the Bed Buddy provides a heat source that is localized to the bed or any other desired area. The bed buddy is charged before use, then removed from the charger when in use.

### BACKGROUND OF THE INVENTION

This invention relates broadly to a space heater. A space heater is an additional localized heat source for the benefit of one specific area. A space heater is a rather inconvenient and inefficient way to localize a heat source. Often an extension cord and careful planning is needed to set up a space heater in a safe and useful manner. The problem with a space heater is its massive and expensive energy consumption, fire hazard, and mobility inconvenience.

It also relates broadly to an electric blanket. The problem with an electric blanket its non-breathing makeup and fire hazard.

This invention is a further description of the invention described in my provisional application No. 60/511,941, conf. no. 6424 and it is my intent to preserve my filing date of Oct. 15, 2003.

### SUMMARY OF THE INVENTION

The present invention is a novel and unobvious localized heat source. This additional localized heat source is for the benefit of a specific area. It is a safe, efficient, energy saving method of staying warm. It is a small rechargeable object that gets warm. It is for people to sleep or snuggle with when they need additional heat especially when temperatures drop. Instead of heating the whole room with a costly space heater, the Bed Buddy provides a heat source that is localized to the bed or any other desired area. The bed buddy is charged before use, then removed from the charger when in use.

It may be placed under bedding to heat the bedding area or snuggled with for a warm, comforting sensation. Once charged, the Bed Buddy provides a localized heat source that can be taken virtually anywhere.

The Bed Buddy can be encased in a variety of forms such as pillows and Teddy bears. These comfortable casings provide a familiar, fun, and cozy embodiment for the user to enjoy.

The Bed Buddy is a heat source composed of a thermal energy storage cell and/or a battery operated heat source that is charged by an electrical current. The make-up of this invention is more apparent as illustrated in the descriptions of drawings below.

### DESCRIPTION OF DRAWINGS

FIG. 1 is a plain view of the heat source in claim 1 of the invention composed of a thermal energy storage cell 11 which is connected to the AC charger 12;

FIG. 2 is a plain view of the heat source in claim 2 of the invention composed of a heat conductor 13 and a chargeable battery 14 which is connected to the AC charger 12;

FIG. 3 is a plain view of the heat source in claim 1 of the invention composed of a thermal energy storage cell 11 which is disconnected to the AC charger 12;

FIG. 4 is a plain view of the heat source in claim 2 of the invention composed of a heat conductor 13 and a chargeable battery 14 which is disconnected to the AC charger 12;

FIG. 5 shows an embodiment of the invention described in claim 3 applying the heat source described in claim 1.

FIG. 6 shows an embodiment of the invention described in claim 3 applying the heat source described in claim 1.

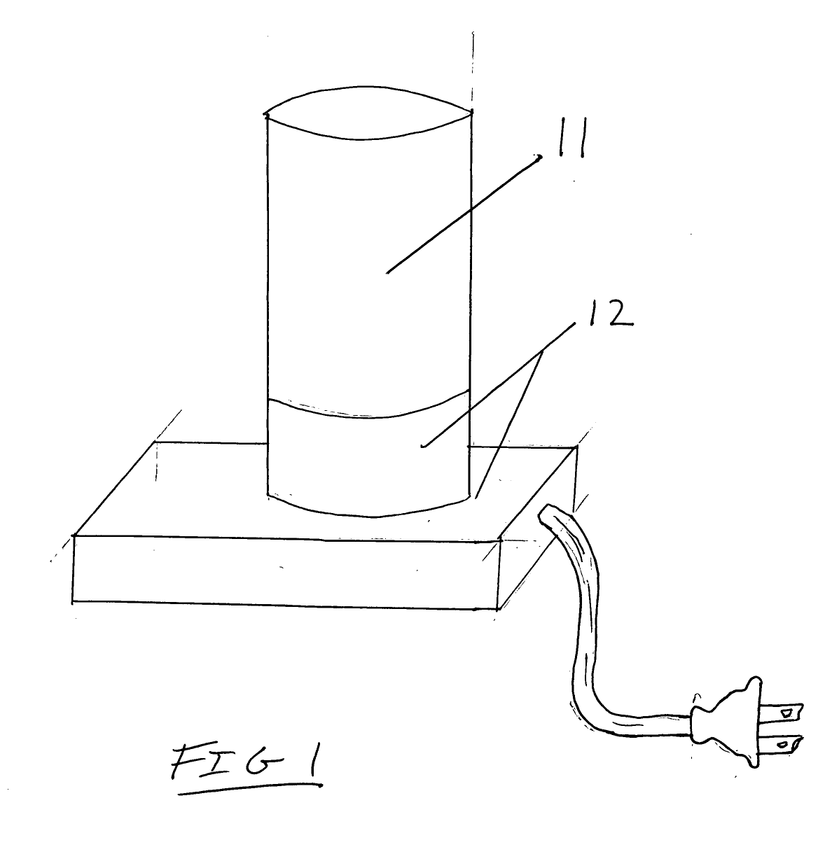

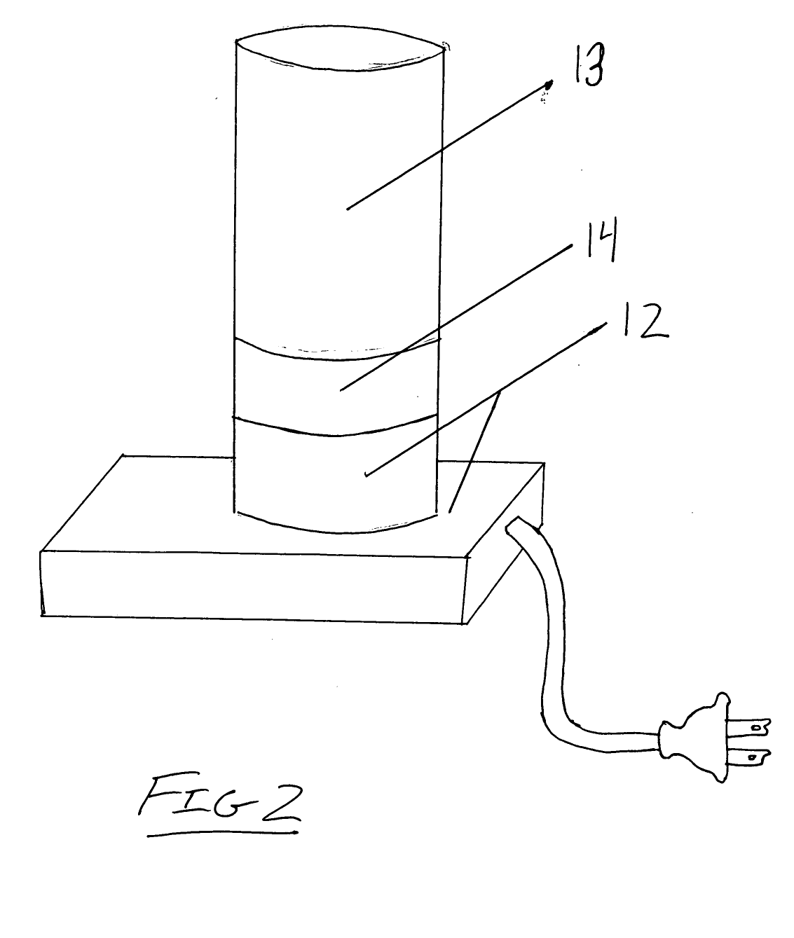

FIGS. 1 and 2 show two embodiments of the invention connected to an AC charger. They are connected to the charger to allow electrical energy to be transferred to the thermal energy storage cell (FIG. 1) and the chargeable battery (FIG. 2).

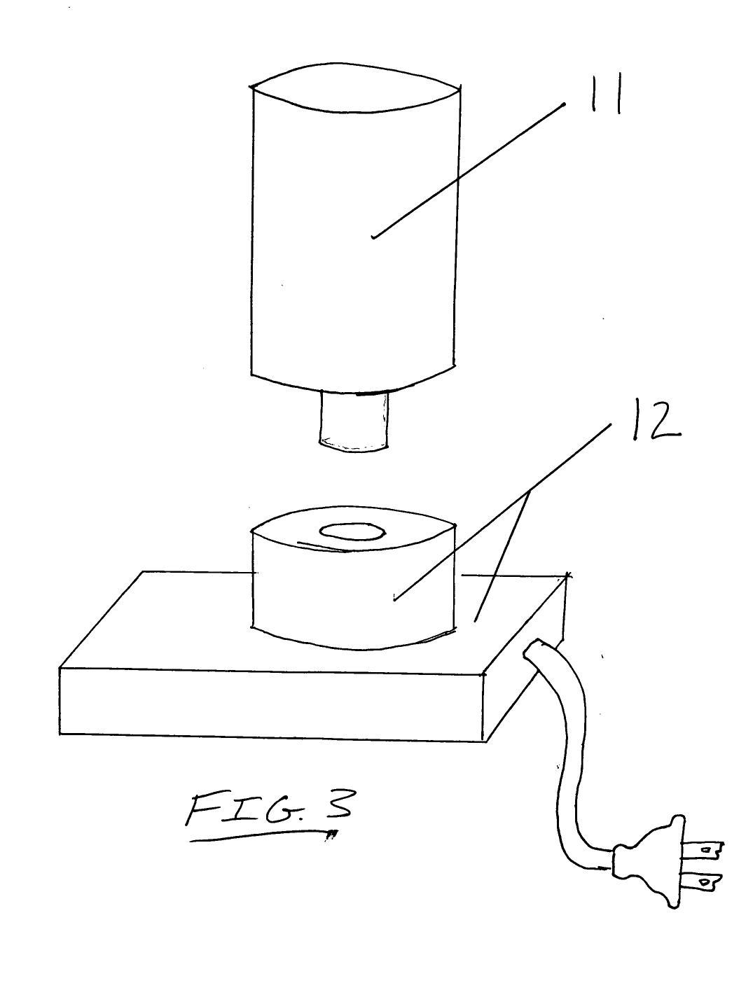

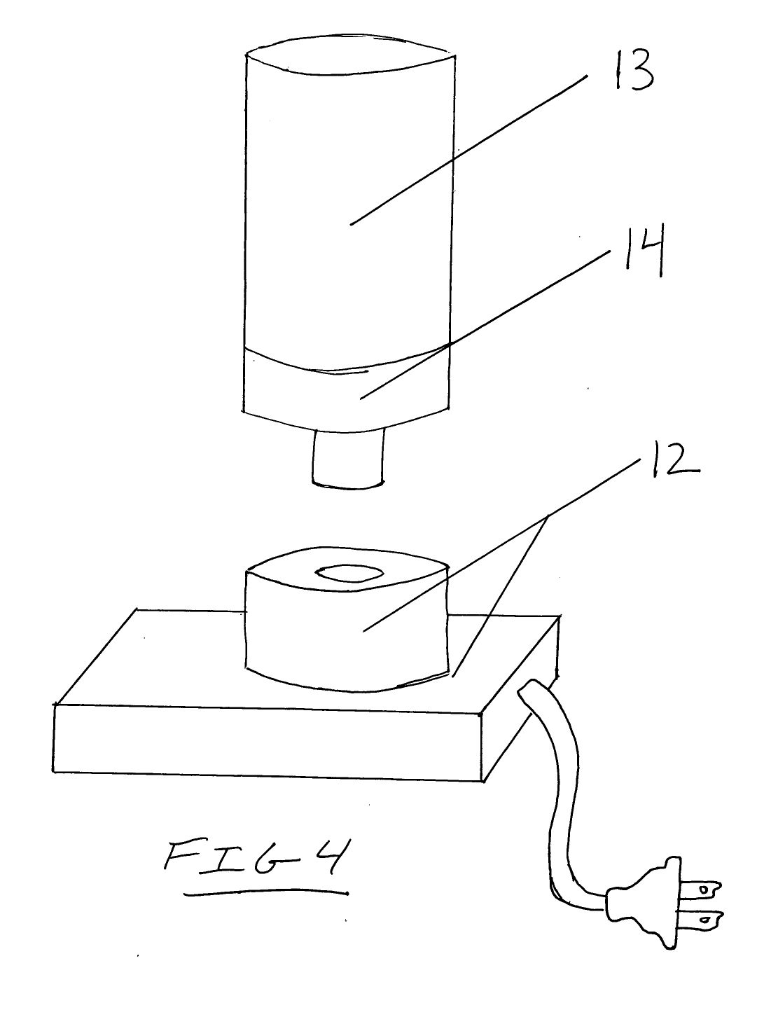

Once the cells are adequately charged, they are removed (FIG. 3 and 4) from the charger 12 and brought into close proximity to the body or area that desires heat.

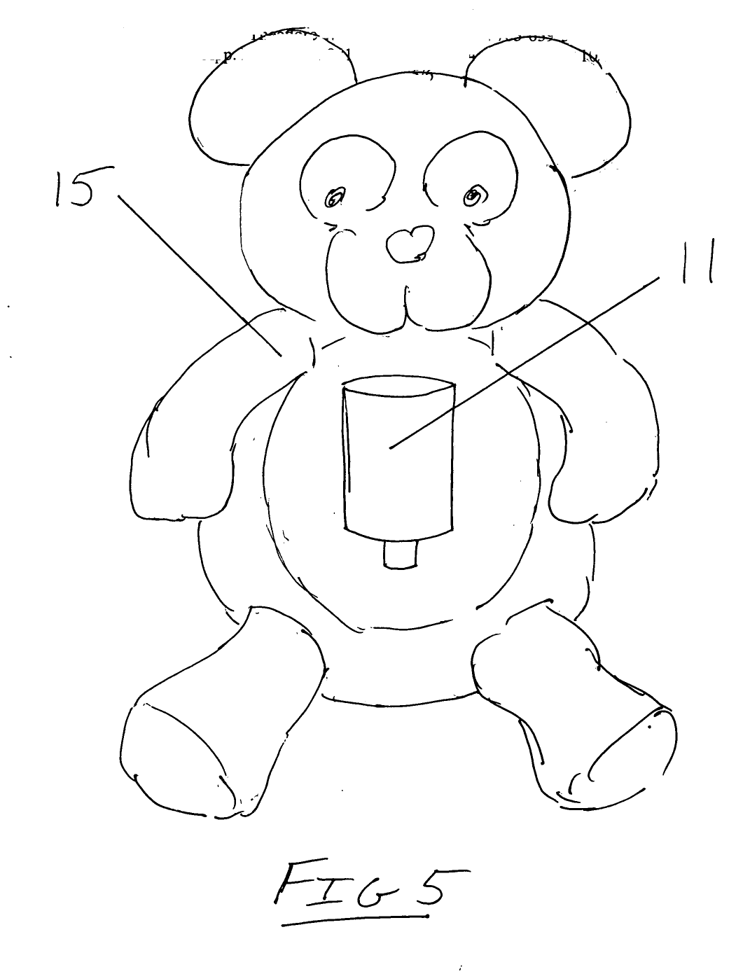

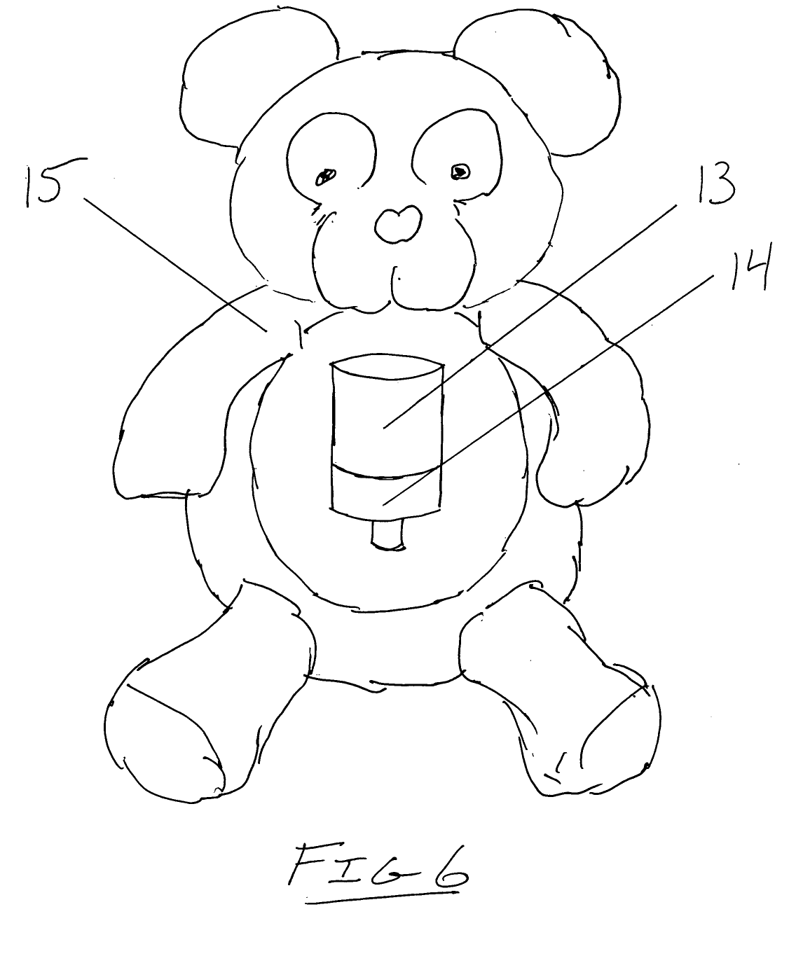

These cells may be encased (FIG. 5 and 6) inside a teddy bear, pillow, or other casing that provides comfort to the user. The cells may either be a permanent part of the casing or removable and interchangeable with other casings.

While the invention has been described and illustrated in detail, it is clearly to be understood that this is intended by way of illustration and example only, and is not to be taken by way of limitating the spirit and scope of this invention.

1. A heat source comprised of:
A thermal energy storage cell;
means for charging the cell; the means comprising an AC electrical charger.

2. A heat source comprised of:
a heat conductor; with
means to provide energy for heat, the means comprising of a chargeable battery;
means for charging the battery; the means comprising an AC electrical charger.

3. Heat source according to claim 1 and/or 2 inside casing, casing taking multiple forms including, but not limited to teddy bears and pillows.
